(19) United States
(12) Patent Application Publication
(10) Pub. No.: US 2006/0176681 A1
(43) Pub. Date: Aug. 10, 2006

(54) Chestlamp

(76) Inventor: Josef Krimmer, Tandern (DE)

Correspondence Address: BUTZEL LONG, 350 SOUTH MAIN STREET, SUITE 300, ANN ARBOR, MI, 48104, US

(21) Appl. No.: 11/325,976

(22) Filed: Jan. 5, 2006

Related U.S. Application Data
(60) Provisional application No. 60/647,624, filed on Jan. 27, 2005.

(30) Foreign Application Priority Data
Jan. 5, 2005 (DE) 20 2005 000 110.4

(51) Int. Cl. F21V 21/108

(52) U.S. Cl. 362/108

(57) ABSTRACT

A chestlamp which is particularly suitable for use during sports activities that involve the use of handheld equipment. The chestlamp includes a lamp and a chest structure to attach the lamp. The belt structure includes a chest belt which can be applied around a person's chest.

### RELATED APPLICATION

This application is based upon U.S. Provisional Patent Application Ser. No. 60/647,624, filed Jan. 27, 2005 to which priority is claimed under 35 U.S.C. §120 and of which the entire specification is hereby expressly incorporated by reference, and also based upon German Utility Model No. 202005000110.4, filed Jan. 5, 2005, to which priority is claimed under 35 U.S.C. §119 and of which the entire specification is hereby expressly incorporated by reference.

### TECHNICAL FIELD

The present invention relates to a chestlamp that includes a lamp and a belt structure to which the lamp is attached. The present invention more particularly relates to a chestlamp that provided for use during sports activities such as Nordic walking.

### BACKGROUND ART

Lamps which do not have to be held separately in one's hand but are carried on a person's body by means of a belt structure are known in the form of headlamps for mountaineers.

In general, headlamps comprise an elastic forehead strap to which a lamp is attached.

Headlamps present a problem in that it is difficult to attach them in a non-slip manner if they are worn over a cap or hat. Because of their inertia, headlamps may also slip in the case of sudden movements of the head. Moreover, the tension of the forehead strap and the weight of the headlamp may cause the wearer to develop a headache.

Since headlamps are worn on a wearer's head, the light beam of the lamp always follows the movement of the wearer's head. However, it is this very feature of headlamps that is disadvantageous during some activities such as walking, hiking, cross-country skiing or Nordic walking. Persons engaged in such activities are usually more interested in having the region in front of their feet illuminated, even when they move their heads to either side or upward or downwards. In particular during sporting activities in which equipment such as sticks have to be held in one's hands, it is not possible to hold a lamp in one's hands. In such instances a lamp that is held on one's body becomes necessary. This requirement is not met by the headlamps or conventional flashlights that are known to date.

Headlamps are also disadvantageous when two or more persons are talking to each other. Usually one turns one's head toward the person one is talking to so that, on one hand, that person's path is not illuminated any longer and, on the other hand, the other person is blinded.

Chest belts for climbers and mountaineers are known. These chest belts are intended to be connected to a rope. The above-mentioned headlamps are used for path illumination.

The present invention provides a lamp that overcomes the drawbacks and disadvantages discussed above, which lamp is particularly well-suited for outdoor activities such as Nordic walking, jogging, cross-country skiing, etc.

### DISCLOSURE OF THE INVENTION

According to various features, characteristics and embodiments of the present invention which will become apparent as the description thereof proceeds, the present invention provides a chestlamp that includes:

at least one lamp; and

a belt structure to which the at least one lamp is attached and supported, said belt structure comprising a chest belt which is configured to be worn about a person's chest.

### BRIEF DESCRIPTION OF DRAWINGS

The present invention will be described with reference to the attached drawings which are given as non-limiting examples only, in which:

FIG. 1 is a perspective view of a chestlamp according to one embodiment of the present invention.

FIG. 1A is a perspective schematic view of a fastening device of a chestlamp according to one embodiment of the present invention.

FIG. 2 is a perspective view of a chestlamp according to another embodiment of the present invention.

FIG. 3 is a perspective view of a chestlamp according to another embodiment of the present invention.

FIG. 4 is a perspective view of a chestlamp according to another embodiment of the present invention which depicts the chestlamp being worn by a person.

### BEST MODE FOR CARRYING OUT THE INVENTION

The present invention is directed to a chestlamp that includes a lamp and a belt structure to which the lamp is attached. The chestlamps that are provided for according to the present invention are particularly well-suited for outdoor activities such as Nordic walking, jogging, cross-country skiing, etc.

Since the chestlamp according to the present invention is worn on a person's chest, it is not coupled to the person's head. Thus, the cone of light does not follow the movement of the person's head. Furthermore, since the chestlamp is arranged at a level below the head, any person one wearing the lamp is talking to will not be blinded even if the person wearing the lamp turns his or her whole body towards that person.

As a rule, a person's chest is aligned in the direction of his or her movement so that the chestlamp constantly illuminates the region in front of the person's feet even if the person turns his or her head to one side. Since it is attached to the chest, the chestlamp is applied at a level that is high enough to ensure good illumination of the region in front of the person's feet.

By providing a shoulder belt according to a further embodiment of the present invention, the chestlamp can be prevented from slipping down. Furthermore, the chestlamp can, thereby, be held in a relatively non-slip manner in front of a person's chest even if the belt structure is applied only loosely.

In a further embodiment, the chestlamp includes a closure that can be provided on the chest belt and/or shoulder belt, which permits one to put on or take off the chestlamp in a comfortable manner. Putting on and taking off the chestlamp in a comfortable manner as well as a tight fit of the belt structures are, furthermore, supported by a further embodiment in which at least some of the parts of the belt structures are made of a strap-like elastic material and/or are otherwise adjustable in length.

It is also possible according to the present invention to remove the lamp from the belt structure(s). Thereby, the lamp can be taken and held in one's hands, if necessary, to selectively allow illumination in certain directions. This is made possible by a further embodiment of the present invention in which the lamp can be attached to the belt structure in a removable manner by means of a fastening device. In a further embodiment of the present invention, the fastening device can comprise an angle adjustment mechanism or structure that allows the lamp to be set to a desired direction of radiation and to be adjusted to the height of different people.

In a further embodiment of the present invention, a rear lamp is additionally provided on the belt structure, that ensures that the person wearing the lamp is noticed from behind even in the dark and is prevented from being easily overlooked particularly in road traffic.

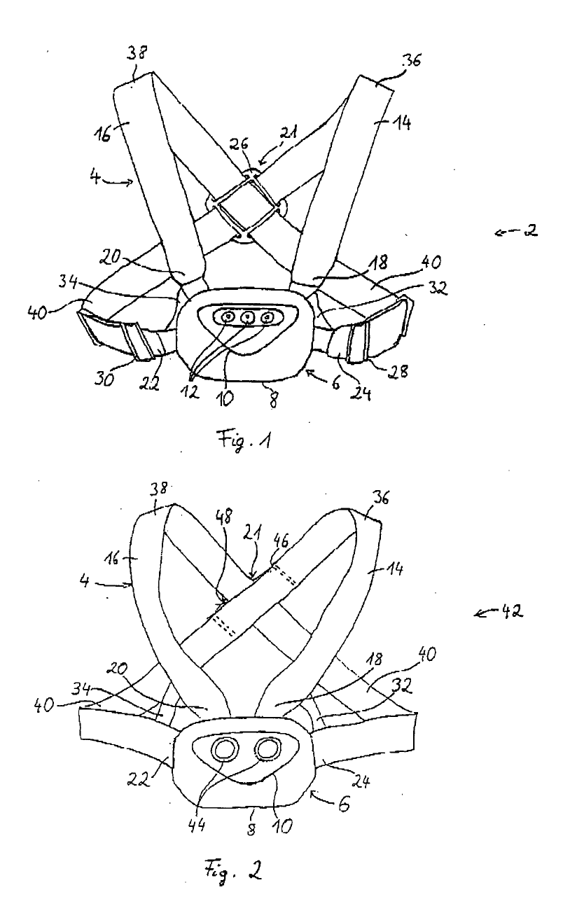

FIG. 1 shows a chestlamp 2 according to one embodiment of the present invention. The chestlamp 2 comprises a belt structure 4 to which a lamp 6 is attached.

The lamp 6 is supplied with electric current by a battery (not show) which is arranged in a lamp housing 8. The front side of the lamp housing 8 is provided with a transparent glass 10 behind which three LEDs 12 are arranged. The lamp housing 8 is further provided with a switch button (not shown) that is used to turn the lamp on and off.

The belt structure 4 of the chestlamp 2 is formed by two chest-shoulder belts 14, 16 which are, at their first ends 18, 20, attached to a fastening device and extend away from the lamp housing 8 in an upward direction. As can be seen from FIG. 1, the two chest-shoulder belts 14, 16 extend away from their first ends 18, 20 in an upward direction, and the backwards and thereafter in a downward direction, intersecting at a crossing point 21, and returning to the lamp housing 8 at the sides thereof. At their second ends 22, 24 the chest-shoulder belts 14, 16 are attached to the fastening device 80.

The fastening device 80, which can be made from a plastic material, as shown in FIG. 1A is arranged on the rear of the lamp housing 8. The fastening device 80 is connected to the belt structure 4 in a non-removable manner, wherein FIG. 1A only shows the ends 18, 20, 22 and 24 of the chest-shoulder belts 14, 16. The fastening device comprises a push-on mechanism in the form of rails 82, 84 and 86 with a snap-in mechanism. The snap-in mechanism is of a conventional type and, in the illustrated embodiment, comprises a pin 88 which is pretensioned in an inward direction into an intermediate space 90 between the rails 82 and 84 by means of a spring (not shown).

The rear (not shown) of the lamp housing 8 is complementary to the rails 82, 84 and 86 in its design. It comprises ribs which are adjusted to the intermediate spaces 90 and 92 between the rails 82, 84 and 86. Furthermore, a recess which is adjusted to the pin 88 is provided at one of the ribs. The lamp 6 is pushed onto the fastening device 80 in a push-on direction 94, wherein the ribs of the lamp 6 enter into engagement with the rails 82, 84 and 86. This engagement is formed by the rails 82, 84 and 86 comprising projection which extend along the rails 82, 84 and 86 in the push-on direction 94 and engage corresponding grooves which are formed on the ribs of the lamp 6. As a result, it is not possible to move the lamp 6 out of the fastening device at right angles to the push-on direction 94. The ribs of the lamp 6 are moved into the fastening device 80 in the push-on direction 94 until the pin 88 of the snap-in mechanism click into place in the recess of the rib of the lamp housing 8. In this position, the fastening device 80 holds the lamp 6 on the belt structure 4 in a stable manner.

The fastening device 80 comprises a front fastening part 98 to which the lamp 6 is attached and a rear fastening part 100 which is connected to the belt structure 4. The front fastening part 98 can be pivoted about a horizontal axis 102 in relation to the rear fastening part 100, to that the angular position of the lamp 6 can be adjusted in relation to the belt structure 4. In the case of the fastening device 80 shown, the angle adjustment mechanism is formed by a cylindrical attachment 104 to the rear fastening part 100, wherein the cylindrical attachment 104 is pivoted in a tray-like receptacle 106 on the front fastening part 98. Herein, the cylindrical attachment 104 can be swiveled about the horizontal axis 102 inside the receptacle 106. Thereby, the lamp 6, when it is used, i.e. worn by a person, can be turned up or down with the result that the distance of the light spot from the feet can be adjusted. It may further be provided that in predetermined angular positions the cylindrical attachment 104 snaps in the tray-like receptacle 106.

A connection part 26 is provided at the crossing point 21 of the chest-shoulder belts 14 and 16, wherein the two chest-shoulder belts 14 and 16 are passed through and connect to each other by the connection part 26. The connection part 26 aligns the chest-shoulder belts 14 and 16 at the crossing point essentially perpendicular to each other and allows the chest-shoulder belts 14 and 16 to be moved along their respective longitudinal directions. Furthermore, buckles 28 and 30 are provided on either chest-shoulder belt 14 and 16, wherein one chest-shoulder belt 14 or 16 is passed through each of the buckles 28 and 30. The buckles 28 and 30 allow one to change the length of and open the chest-shoulder belts 14 and 16. Lateral straps 32 and 34 aligning the two chest-shoulder belts 14 and 16 in relationship to each other in the region of the lamp 6 each extend between first end 2 of the second chest-shoulder belt 16 as well as between the first end 20 of the second chest-shoulder belt 16 and the second end 22 of the first chest-shoulder belt 14.

The chest-shoulder belts 14 and 16 are, for example, made of leather bands, nylon bands or elastic rubber bands. The lateral straps 32 and 34 are, preferably, made of an elastic material, such as rubber.

During operation, when the chestlamp is worn by a person, the sections of the chest-shoulder belts 14 and 16 that are arranged between the respective first ends 18 and 20 and the crossing point 21 form two shoulder belts 36 and 38 which are passed across a person's shoulders. Together, the sections of the chest-shoulder belts 14 and 16 that are arranged between the crossing point 21 and the respective second ends 22 and 24 form a chest belt 40 which is applied around a person's chest, The lamp 6 is held on the person's chest by means of the belt structure 4.

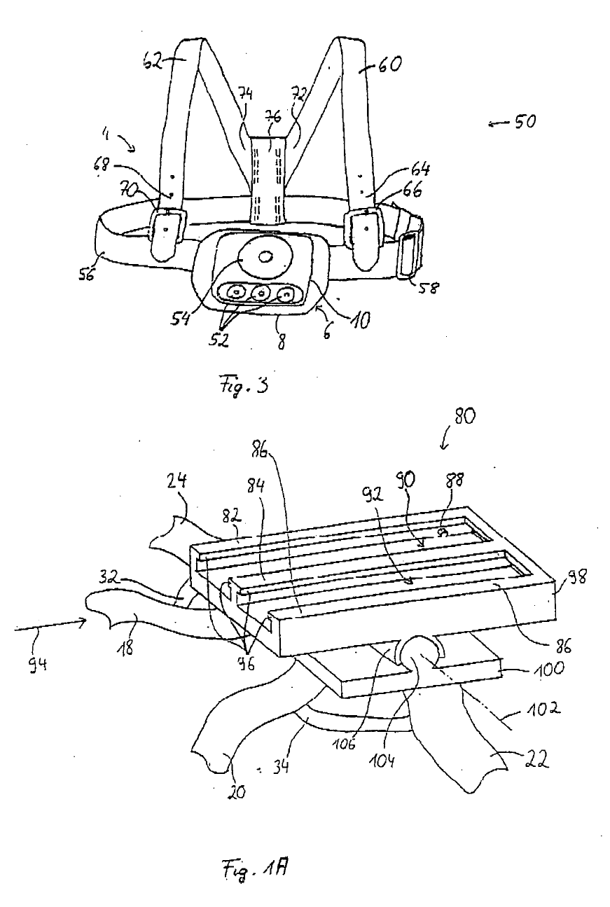

FIG. 2 shows a chestlamp 42 according to another embodiment of the present invention. A multitude of features of the belt structure 4 and the lamp 6 are designed similar to the embodiment of the chestlamp of FIGS. 1 and 1A. Accordingly, only the different structures and features will be discussed in detail.

The lamp 6 according to the embodiment of the invention shown in FIG. 2 comprises two halogen lamps 44 which are arranged behind a transparent glass 10 of a lamp housing 8.

The belt structure is again formed by two chest-shoulder belts 14 and 16. As in the case of the chestlamp of FIGS. 1 and 1A, the sections of the respective ends 18 and 20 and the crossing point 21 of the chest-shoulder belts 14 and 16 form two shoulder belts 36 and 38 which are each passed across a person's shoulders. Together, the sections of the chest-shoulder belts 14 and 16 that are arranged between the crossing point 21 and the respective second ends 22 and 24 form a chest belt 40 which is applied around a person's chest.

As in the case of the chestlamp of FIGS. 1 and 1A, two lateral straps 32 and 34 are provided which align the two chest-shoulder belts 14 and 16 in relationship to each other in the region of the lamp 6. Furthermore, a fastening device as has been described above is provided and used to attach the lamp 6 to the belt structure 4.

The chest-shoulder belts 14 and 16 are made of an elastic strap-like material. As a result, the chest-shoulder belts 14 and 16 expand while the chestlamp 42 is put on and taken off, so that putting on and taking off the chestlamp can be achieved in a comfortable manner. Once the chestlamp 42 is put on, the elasticity of the chest-shoulder belts 1 and 16 ensures a tight seat of the chestlamp 42. Herein, the lamp 6 is arranged on the person's chest.

In the region of the crossing point 21, a strap section 46 is sewed onto the first chest-shoulder belt 14, with the result that a loop 48 is formed between the first chest-shoulder belt 14 and the strap section 46, with the second chest-shoulder belt 16 being passed through the loop 48. Accordingly, the second chest-shoulder belt 16 can be moved through the loop along its longitudinal direction.

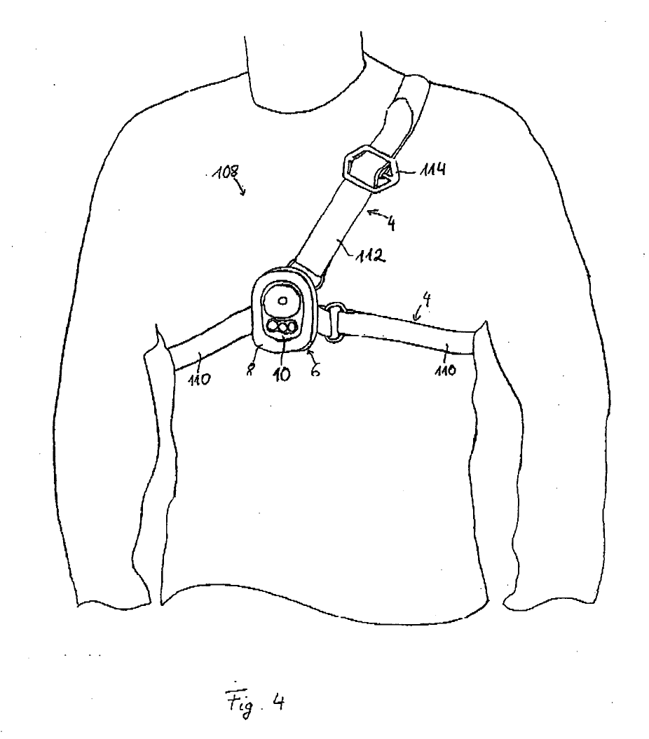

FIG. 3 shows a chestlamp 50 according to another embodiment of the present invention. A multitude of features of the belt structure 4 and the lamp 6 are designed similar to the embodiment of the chestlamp of FIGS. 1 and 1A. Accordingly, only the different structures and features between the chestlamp shown in FIG. 3 and that shown and discussed above with reference to FIGS. 1 and 1A will be discussed in reference to FIG. 3.

The chestlamp 50 comprises a lamp 6 and a belt structure 4 to attach the lamp 6. Three LEDs 52 and one halogen lamp 54 are arranged behind a transparent glass 10 of a lamp housing 8 of the lamp 6. Furthermore, a switch button (not shown) is provided at the lamp housing 8, wherein, optionally, either only the LEDs 52, only the halogen lamp 54 or the LEDs 52 together with the halogen lamp 54 can be turned on as desired.

The belt structure 4 comprises a chest belt 56 which is applied around a person's chest. The chest belt 56 is passed through a buckle 58 which is provided on the chest belt 56. The buckle 58 allows opening and adjustment of the length of the chest belt 56.

On its rear, the lamp housing 8 comprises an eyelet (not shown) or a slot through which the chest belt 56 is passed. Thereby, the lamp 6 is attached to the belt structure 4.

Furthermore, the belt structure 4 comprises two shoulder belts 60 and 62 which can each be passed across a person's shoulders. With a first end 64, a first shoulder belt 60 is attached to the chest belt 56 by means of a buckle 70 to the right of the lamp as depicted. With a first end 68, the second shoulder belt 62 is also attached to the chest belt 56 by means of a buckle 70.

As can be seen from FIG. 3, the two shoulder belts 60 and 62 are attached with their second ends 72 and 74 to the chest belt 56 at a position opposite to the lamp 6. The second ends 72 and 74 of the shoulder belts 60 and 62 are both sewed onto a flap 76 which is made of a strap-like material, wherein the flap 76 is, in turn, sewed onto the chest belt 56.

When the chestlamp shown in FIG. 3 is put on by a person, the person's left arm is passed out between the first shoulder belt 60 and the chest belt 56 and the person's right arm is passed out between the second shoulder belt 62 and the chest belt 56. The lamp 6 is arranged on the person's chest.

FIG. 4 shows a chestlamp according to another embodiment of the present invention which is worn by a person. A multitude of features of the belt structure 4 and the lamp 6 which comprises a lamp housing 8 and a glass 10 behind which one halogen lamp and three LEDs are arranged are provided according to the preceding embodiments. The lamp 6 is, for example, attached to the belt structure 4 by means of a fastening device as described above with reference to FIG. 1A. Accordingly, only the different structures and features between the chestlamp shown in FIG. 4 and that shown and discussed above with reference to FIGS. 1, 1A, 2 and 3 will be discussed in reference to FIG. 4.

The belt structure 4 comprises a chest belt 110 which is applied around a person's chest, with the result that the lamp 6 is arranged centrally on the person's chest. Furthermore, a shoulder belt 112 is provided which extends away from the lamp 6 via one of the person's shoulders and then in a backward direction to a section of the chest belt 110 to which it is attached. The shoulder strap 112 prevents the chestlamp 108 from slipping down and restricts the person's freedom of movement only to a minor degree.

The chest belt 110 and the shoulder belt 112 are made of an elastic material. Furthermore, a buckle 114 that allows adjustment of the length and opening and closing of the shoulder belt 112 is provided on the shoulder belt 112.

It is to be understood that the lamp can also be attached to other parts of the belt structure. For example, the lamp can be attached to one of the shoulder belts. Furthermore, the belt structure can be provided in various executive forms. In its more simple executive form, the belt structure is merely formed by a chest belt, the design of which is similar to that of the chest belt of the embodiment of the invention depicted in FIG. 3 and to which the lamp is attached. In addition to such a chest belt, it is also possible to provide only a single shoulder belt.

As the embodiments depicted in FIGS. 1, 1A and 2 show, the chest belt can also be formed by a multitude of belt sections. This is also possible for the shoulder belts.

A rear lamp which is attached to the belt structure at a position that is arranged opposite to the lamp shown can be provided in addition to the lamp shown. When the chestlamp is worn by a person, the rear lamp is arranged on the person's back. If desired, a rear lamp that emits red light and/or a flashing light can be provided with the result that the person will be better noticed in road traffic in the dark. In the embodiment of the invention shown in FIG. 1, the rear lamp can, for example, be attached to the connection part 26.

The lamp shown and also the rear lamp can comprise one or more LEDs, halogen lamps, conventional incandescent lamps, xenon lamps, or a multitude of various known lamps. Furthermore, the lamp(s) can be provided with a switch button or a separate changeover button that can be used to activate various lighting modes, such as coloring light, flashing light, optional illumination by a halogen lamp or LED's, either separately or together, brighter light or weakened light, etc. In essence, lamps which are also used for conventional flashlight or headlamps and are adapted for attachment to the belt structure of the chestlamps are suitable for use according to the present invention.

In the embodiment shown, the primary battery of the secondary battery for supplying the lamp(s) with electric current is arranged inside the lamp housing. However, similar to known headlamps, it is also possible to attach a separate battery to the belt structure, wherein power cables can run from the battery housing to the lamp(s), including any rear lamp that might be used.

The belt structure can also be narrower than shown in the figures. Moreover, the closures or buckles can be attached to other positions of the belt structure and designed differently than shown in the figures. For example, a closure can also be formed by two closure parts which can be clipped together and to each of which an end of the belt is attached. Such a closure allows quick opening and closing of the belt.

In the embodiments shown, the individual belts can be adjusted in their lengths and/or are elastic. Furthermore, sections of the belt structures, such as those extending away from the lamp(s) can be made of an elastic material.

A fastening device to attach the lamp(s) to the belt structure can also be an integral part of the lamp(s). In particular, the angle adjustment mechanism of the fastening device can be formed on the rear of the lamp(s) of lamp housing. Furthermore, it is possible to design the angle adjustment mechanism such that it permits lateral angular adjustment, i.e. swiveling of the lamp(s) about a vertical axis. Thereby, it is not only possible to adjust the distance of the light spot from the wearer's feet, but also to align the light beam from side to side.

Further removable fastenings can, for example, also be implemented in the form of a clip to clip in the lamp(s) or in the form of a bracket which is swiveled about a fastening section of the lamp and then snaps in.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

What is claimed is:

1. A chestlamp that comprises:
at least one lamp; and
a belt structure to which the at least one lamp is attached and supported, said belt structure comprising a chest belt which is configured to be worn about a person's chest.

2. A chestlamp according to claim 1, wherein the belt structure comprises at least one shoulder belt which is configured to pass across a person's shoulder when the chestlamp is worn.

3. A chestlamp according to claim 1, further comprises a fastener that attaches the at least one lamp to the belt structure.

4. A chestlamp according to claim 3, wherein the fastener is arranged on the belt structure so as to position the at least one lamp to point in front of a person's chest while the chestlamp is worn.

5. A chestlamp according to claim 3, wherein the fastener is configured to adjust the angular position of the at least one lamp.

6. A chestlamp according to claim 3, wherein the fastener is configured to removably attach the at least one lamp to the belt structure.

7. A chestlamp according to claim 6, wherein the fastener is configured to adjust the angular position of the at least one lamp.

8. A chestlamp according to claim 2, further comprises a fastener that attaches the at least one lamp to the belt structure.

9. A chestlamp according to claim 8, wherein the fastener is arranged on the belt structure so as to position the at least one lamp to point in front of a person's chest while the chestlamp is worn.

10. A chestlamp according to claim 8, wherein the fastener is configured to adjust the angular position of the at least one lamp.

11. A chestlamp according to claim 8, wherein the fastener is configured to removably attach the at least one lamp to the belt structure.

12. A chestlamp according to claim 11, wherein the fastener is configured to adjust the angular position of the at least one lamp.

13. A chestlamp according to claim 1, further comprising a closure that is provided on the chest belt which closure allows the chest belt to be opened or closed.

14. A chestlamp according to claim 2, further comprising a closure that is provided on at least one of the chest belt and the at least one shoulder belt which closure allows the respective chest belt and shoulder belt to be opened or closed.

15. A chestlamp according to claim 1, wherein at least portions of the belt structure are adjustable in length.

16. A chestlamp according to claim 15, wherein at least portions of the belt structure are made from an elastic material.

17. A chestlamp according to claim 1, further comprising a battery for supplying electric current to the at least one lamp.

18. A chestlamp according to claim 1, further comprising at least one additional lamp that coupled to the belt structure so as to face rearward of a person while the chestlamp is worn.

19. A chestlamp according to claim 2, wherein the at least one shoulder belt comprises two shoulder belts.

20. A chestlamp according to claim 19, wherein the two shoulder belts intersect one another while the chestlamp is worn.
